(19) United States
(12) Patent Application Publication
(10) Pub. No.: US 2009/0319890 A1
(43) Pub. Date: Dec. 24, 2009

(54) DATA PROCESSING APPARATUS WHICH DOWNLOADS DATA VIA NETWORK, DATA PROCESSING METHOD, AND DATA PROCESSING PROGRAM EMBODIED ON COMPUTER READABLE MEDIUM

(75) Inventor: Haruna MIWA, Itami-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/485,412

(22) Filed: Jun. 16, 2009

(30) Foreign Application Priority Data
Jun. 20, 2008 (JP) 2008-161148

(51) Int. Cl. G06F 17/21; G06F 17/00

(52) U.S. Cl. 715/274; 715/273

(57) ABSTRACT

In order to facilitate processing on page data written in a markup language, an MFP includes an operation control portion to accept a user operation, a display control portion to display data, a data acquiring portion to acquire a Web page, a browsing portion to cause the display control portion to display Web page, an analyzing portion to analyze the acquired Web page, to extract an operation to be performed on the acquired Web page, an assigning portion to assign at least one operation to at least one of a plurality of keys based on a result of the analysis, and an operation display adding portion to cause the display control portion to display at least one set of key identification information for identifying the key to which an operation is assigned and operation identification information for identifying the operation which is assigned to the key.

This application is based on Japanese Patent Application No. 2008-161148 filed with Japan Patent Office on Jun. 20, 2008, the entire content of which is hereby incorporated by reference.

### BACKGROUND OF THE INVENTION

1. Field of the Invention

The present invention relates to a data processing apparatus, a data processing method, and a data processing program embodied on a computer readable medium. More particularly, the present invention relates to a data processing apparatus which downloads data via a network, and a data processing method and a data processing program embodied on a computer readable medium which are executed in the data processing apparatus.

2. Description of the Related Art

Recently, a composite machine called a multi function peripheral (MFP) provided with scanning, printing, copying, and facsimile transmitting/receiving functions may also include, as a pointing device, a touch panel superimposed on a liquid crystal display (LCD). The LCD included in the MFP, however, is smaller in size than the one included in a personal computer and the like. The MFP may also be provided with a browsing function. Such an MFP may be connected to the Internet to download a Web page from a Web server and the like for display.

Many of Web pages, however, are generally generated on the assumption that they are browsed using the pointing device such as a mouse. Thus, for example, it may be difficult for the user to scroll a screen by designating a scroll bar on the touch panel.

### SUMMARY OF THE INVENTION

The present invention has been accomplished in view of the foregoing problems, and an object of the present invention is to provide a data processing apparatus which facilitates processing on page data written in a markup language.

Another object of the present invention is to provide a data processing method which facilitates processing on page data written in a markup language.

A further object of the present invention is to provide a data processing program embodied on a computer readable medium which facilitates processing on page data written in a markup language.

In order to achieve the above-described objects, according to an aspect of the present invention, a data processing apparatus includes: an operation accepting portion to accept an operation of a user, the operation accepting portion having a plurality of keys; a display control portion to display data; a data acquiring portion to acquire page data written in a markup language; a browsing portion to cause the display control portion to display the page data; an analyzing portion to analyze the acquired page data to extract an operation to be performed on the acquired page data; an assigning portion to assign at least one operation to at least one of the plurality of keys based on a result of the analysis; and an operation display portion to cause the display control portion to display at least one set of key identification information for identifying the key among the plurality of keys to which an operation is assigned and operation identification information for identifying the operation which is assigned to the key.

According to another aspect of the present invention, a data processing apparatus includes: an operation accepting portion to accept an operation of a user, the operation accepting portion having a plurality of keys; a data acquiring portion to acquire page data written in a markup language; an analyzing portion to analyze the acquired page data to extract an operation to be performed on the acquired page data; an assigning portion to assign at least one operation to at least one of the plurality of keys based on a result of the analysis; and an adding portion to add to the page data a description for displaying at least one set of key identification information for identifying the key among the plurality of keys to which an operation is assigned and operation identification information for identifying the operation which is assigned to the key.

According to a further aspect of the present invention, a data processing method is carried out in a computer, the computer including an operation accepting portion and a display control portion, the operation accepting portion having a plurality of keys and accepting an operation of a user, the display control portion displaying data, wherein the method includes the steps of: acquiring page data which is written in a markup language; causing the display control portion to display the page data; analyzing the acquired page data; assigning at least one operation to at least one of the plurality of keys based on a result of the analysis; and causing the display control portion to display at least one set of key identification information for identifying the key among the plurality of keys to which an operation is assigned and operation identification information for identifying the operation which is assigned to the key.

According to a still further aspect of the present invention, a data processing method is carried out in a computer, the computer including an operation accepting portion having a plurality of keys and accepting an operation of a user, wherein the method includes the steps of: acquiring page data which is written in a markup language; analyzing the acquired page data; assigning at least one operation to at least one of the plurality of keys based on a result of the analysis; and adding to the page data a description for displaying at least one set of key identification information for identifying the key among the plurality of keys to which an operation is assigned and operation identification information for identifying the operation which is assigned to the key.

According to yet another aspect of the present invention, a data processing program embodied on a computer readable medium is executed by a computer including an operation accepting portion and a display control portion, the operation accepting portion having a plurality of keys and accepting an operation of a user, the display control portion displaying data, wherein the program causes the computer to execute the steps of: acquiring page data which is written in a markup language; causing the display control portion to display the page data; analyzing the acquired page data; assigning at least one operation to at least one of the plurality of keys based on a result of the analysis; and causing the display control portion to display at least one set of key identification information for identifying the key among the plurality of keys to which an operation is assigned and operation identification information for identifying the operation which is assigned to the key.

According to yet another aspect of the present invention, a data processing program embodied on a computer readable medium is executed by a computer, the computer including an operation accepting portion having a plurality of keys and accepting an operation of a user, wherein the program causes the computer to execute the steps of: acquiring page data which is written in a markup language; analyzing the acquired page data; assigning at least one operation to at least one of the plurality of keys based on a result of the analysis; and adding to the page data a description for displaying at least one set of key identification information for identifying the key among the plurality of keys to which an operation is assigned and operation identification information for identifying the operation which is assigned to the key.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing an information processing system according to an embodiment of the present invention.

FIG. 2 is a perspective view of an MFP.

FIG. 3 is a block diagram showing an example of the circuit configuration of the MFP.

FIG. 4 is a plan view showing an example of an operation panel.

FIG. 5 is a functional block diagram showing an example of the functions of a CPU.

FIG. 6 is a first plan view showing an operation panel displaying a Web page.

FIG. 7 is a second plan view showing an operation panel displaying the Web page.

FIG. 8 is a flowchart illustrating an example of the flow of conversion processing.

### DESCRIPTION OF THE PREFERRED EMBODIMENTS

Embodiments of the present invention will now be described with reference to the drawings. In the following description, like reference 5 characters denote like parts, which have like names and functions, and therefore, detailed description thereof will not be repeated.

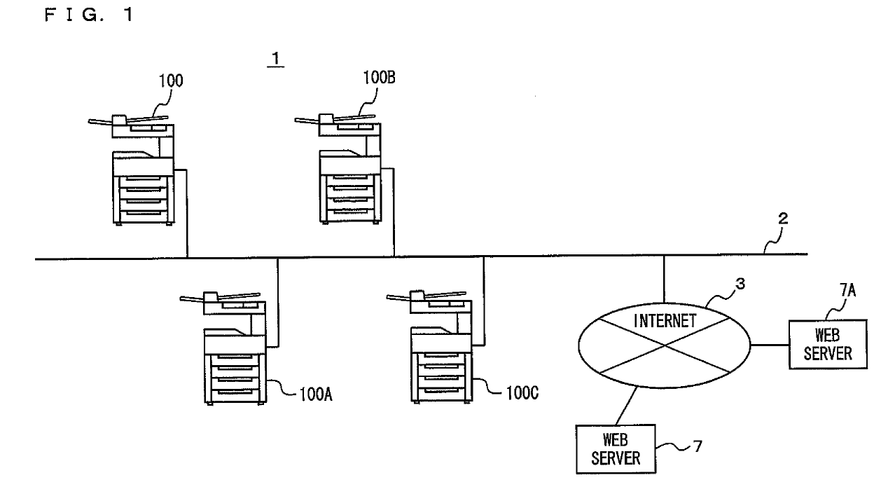

FIG. 1 schematically shows an information processing system according to an embodiment of the present invention. Referring to FIG. 1, an information processing system 1 includes composite machines (hereinafter, referred to as “MFPs”) 100, 100A, 100B, and 100C, which are connected to a network 2. MFPs 100, 100A, 100B, and 100C are examples of a data processing apparatus, which is provided with a plurality of functions such as scanning, printing, copying, and facsimile transmitting/receiving functions.

Network 2 is a local area network (LAN), which may be connected in a wired or wireless manner. Network 2 is not necessarily the LAN; it may be a wide area network (WAN), public switched telephone networks (PSTN), and the like. Network 2 is connected to the Internet 3 via a gateway. MFPs 100, 100A, 100B, and 100C are capable of communicating with Web servers 7, 7A which are connected to Internet 3.

MFPs 100, 100A, 100B, and 100C are capable of executing a browsing program; i.e., they each have the browsing function. For example, when a user designates a uniform resource locator (URL) of a Web page stored in Web server 7, MFP 100 requests transmission of the Web page specified by the URL from Web server 7, and receives and displays the Web page transmitted from Web server 7. Hereinafter, the process carried out by MFPs 100, 100A, 100B, and 100C to download and display a Web page will be called a “browsing process”.

While MFPs 100, 100A, 100B, and 100C will be described as examples of the data processing apparatus in the present embodiment, the data processing apparatus is not limited to MFPs 100, 100A, 100B, and 100C, and may be any apparatus provided with the browsing function, such as a personal computer, scanner, printer, or facsimile machine. MFPs 100, 100A, 100B, and 100C are provided with the same functions, and thus, MFP 100 will be described representatively.

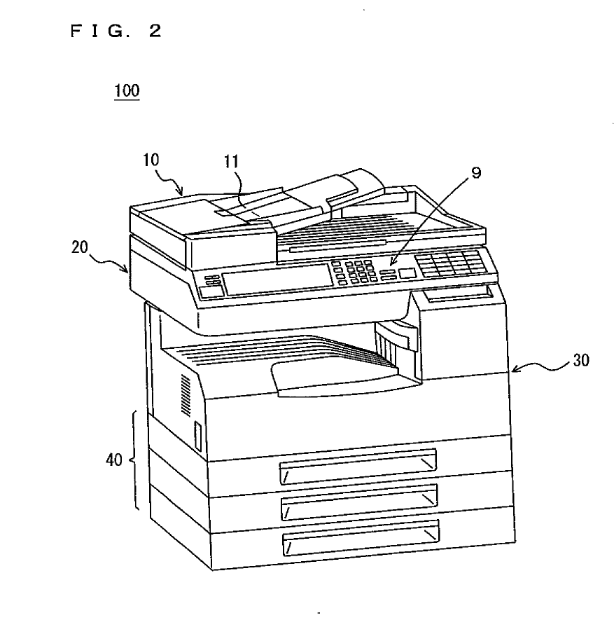

FIG. 2 is a perspective view of the MFP. Referring to FIG. 2, MFP 100 includes an automatic document feeder (ADF) 10, an image reading portion 20, an image forming portion 30, and a paper feeding portion 40.

ADF 10 automatically carries a plurality of documents set in a document feed tray 11 one by one to a predetermined document reading position set on a platen glass of image reading portion 20, and discharges the documents for which the images were read by image reading portion 20 to a document output tray. Image reading portion 20 includes a light source for illuminating the document delivered to the document reading position with light, and a photoelectric conversion element for receiving the light reflected from the document. Image reading portion 20 scans the image of the document in accordance with the size of the document. The photoelectric conversion element converts the received light into electric signals, or image data, and outputs the image data to image forming portion 30. Paper feeding portion 40 carries sheets of paper stored in a paper feed tray to image forming portion 30.

Image forming portion 30 forms an image using well-known electrophotography. It performs various kinds of data processing, including shading compensation, on the image data input from image reading portion 20, to form an image on the sheet of paper carried from paper feeding portion 40, based on the image data on which the data processing has been performed.

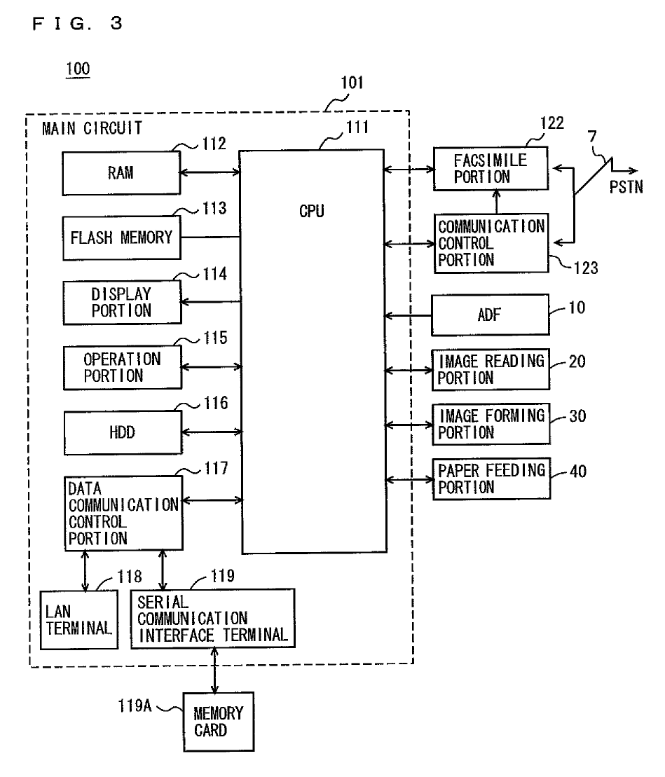

FIG. 3 is a block diagram showing an example of the circuit configuration of the MFP. Referring to FIG. 3, MFP 100 includes a main circuit 101, a facsimile portion 122, and a communication control portion 123. Main circuit 101 includes a central processing unit (CPU) 111, a random access memory (RAM) 112 used as a work area for CPU 111, a flash memory 113 for storing a program executed by CPU 111 and the like, a display portion 114, an operation portion 115, a hard disk drive (HDD) 116 serving as a mass storage, and a data communication control portion 117.

CPU 111 carries out various kinds of processing by executing the programs stored in flash memory 113. Flash memory 113 is an electrically erasable and programmable read only memory (EEPROM).

CPU 111 is connected with display portion 114, operation portion 115, HDD 116, and data communication control portion 117, and is responsible for overall control of main circuit 101. Further, CPU 111 is connected with facsimile portion 122, communication control portion 123, ADF 10, image reading portion 20, image forming portion 30, and paper feeding portion 40, and is responsible for overall control of MFP 100.

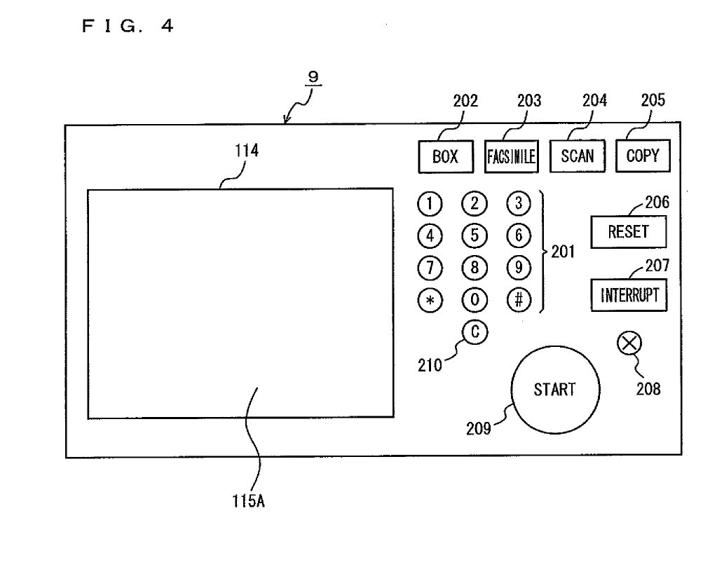

Display portion 114 is a display such as a liquid crystal display (LCD), an organic electro-luminescence display (organic ELD) or the like, and displays an instruction menu for the user, information about acquired image data, and others. Operation portion 115, which is provided with a plurality of keys, accepts data input such as instructions, characters, and numerical characters, according to the key operations by the user. The keys included in operation portion 115 are hard keys provided with switches. Operation portion 115 includes a touch panel 115A (see FIG. 4) provided on display portion 114. The touch panel 115A may be a resistive film-type touch panel or a surface acoustic wave-type touch panel, although it is not particularly restricted thereto. The touch panel 115A detects the position pointed by a finger or a stylus pen, and outputs the coordinates of the detected position to CPU 111. Display portion 114 and operation portion 115 substantially constitute an operation panel 9 provided on an upper surface of MFP 100.

Data communication control portion 117 includes a LAN terminal 118 which is an interface for communication according to a communication protocol such as transmission control protocol (TCP) or user datagram protocol (UDP), and a serial communication interface terminal 119 for serial communication. Data communication control portion 117 transmits and receives data to and from an external device connected to LAN terminal 118 or serial communication interface terminal 119, in accordance with an instruction from CPU 111.

When a LAN cable for connection to network 2 is connected to LAN terminal 118, data communication control portion 117 communicates with other MFPs 100A, 100B, and 100C connected to network 2, via LAN terminal 118. Data communication control portion 117 also communicates with Web servers 7, 7A connected to Internet 3.

CPU 111 controls data communication control portion 117 to download a program from a computer connected to network 2 or Internet 3 and store the program in flash memory 113, which enables updating of the program. The program includes a data processing program, which will be described later.

A memory card 119A with a flash memory built therein may be connected to serial communication interface terminal 119. CPU 111 controls data communication control portion 117 to read from memory card 119A the program to be executed by CPU 111 and store the program in flash memory 113, whereby the program can be updated.

It is noted that the recording medium for storing the program to be executed by CPU 111 is not restricted to memory card 119A. It may be a flexible disk, a cassette tape, an optical disc (compact disc-ROM (CD-ROM), magneto-optical (MO) disc, mini disc (MD), digital versatile disc (DVD)), an IC card (including a memory card), an optical card, or a semiconductor memory such as a mask ROM, an erasable and programmable ROM (EPROM), an EEPROM, or the like.

Alternatively, CPU 111 may download the program from a computer connected to network 2 and store the program in flash memory 113, or a computer connected to network 2 may write the program to flash memory 113, and thereafter, the program stored in flash memory 113 may be loaded to RAM 112 for execution by CPU 111. As used herein, the “program” includes, not only the program which CPU 111 can execute directly, but also a source program, a compressed program, an encrypted program, and others.

Communication control portion 123 is a modem for connecting CPU 111 to public switched telephone networks (PSTN) 7. MFP 100 has a pre-assigned telephone number in PSTN 7. When a call is originated from a facsimile machine connected to PSTN 7 to the telephone number assigned to MFP 100, communication control portion 123 detects the call. Upon detection of the call, communication control portion 123 establishes connection between the facsimile machine and MFP 100 to cause facsimile portion 122 to communicate with the facsimile machine.

Facsimile portion 122 is connected to PSTN 7, and transmits facsimile data to or receives facsimile data from PSTN 7.

FIG. 4 is a plan view showing an example of the operation panel. Referring to FIG. 4, operation panel 9 includes display portion 114 and operation portion 115. Operation portion 115 includes: a ten-key pad 201; a box key 202 for manipulating data stored in HDD 116; a facsimile key 203 for causing MFP 100 to enter a facsimile mode for execution of a process of transmitting/receiving facsimile data; a scan key 204 for causing MFP 100 to enter a scan mode for execution of a scanning process; a copy key 205 for causing MFP 100 to enter a copy mode for execution of a copying process; a reset key 206 for resetting MFP 100 to its initial state; an interrupt key 207 for setting an interrupt process; a pause key 208 for pausing an ongoing process; a start key 209 for starting a process; and a clear key 210 for canceling the input content.

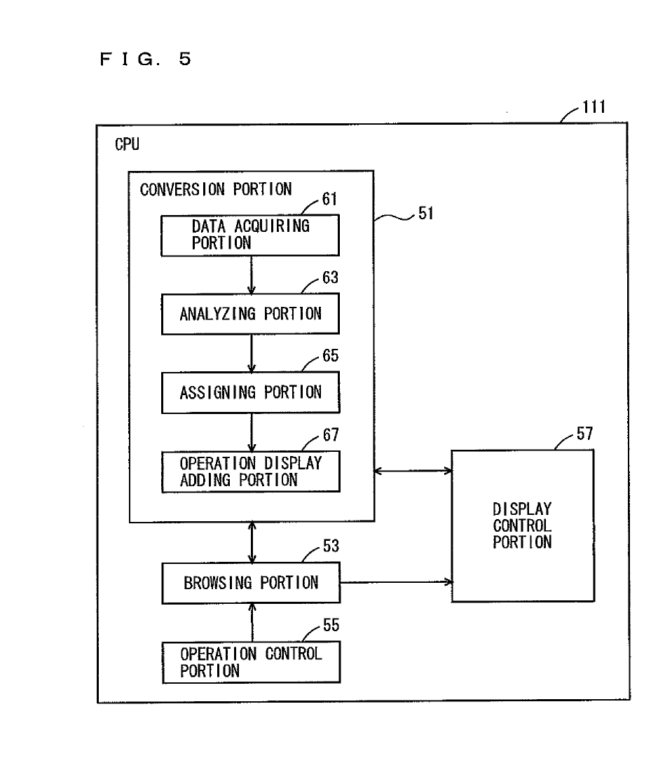

FIG. 5 is a functional block diagram schematically showing the functions of the CPU. Referring to FIG. 5, CPU 111 includes: a browsing portion 53 to display a Web page downloaded from Web server 7, 7A; a conversion portion 51 to download and convert the Web page for which downloading was instructed by browsing portion 53; an operation control portion 55 to control operation portion 115; and a display control portion 57 to control display portion 114.

Browsing portion 53 is formed in CPU 111 as CPU 111 executes a browsing program. When a user inputs to operation portion 115 a URL assigned to a Web page which is stored in one of Web servers 7, 7A, browsing portion 53 receives the URL from operation control portion 55. Browsing portion 53 outputs a download instruction to data communication control portion 117 via conversion portion 51. The download instruction directs data communication control portion 117 to download the Web page that is specified by the URL received from operation control portion 55, from the corresponding one of Web servers 7, 7A. Browsing portion 53 acquires via conversion portion 51 the Web page received by data communication control portion 117, and outputs the acquired Web page to display control portion 57. Display control portion 57 display on display portion 114 an image of the Web page input from browsing portion 53.

Conversion portion 51 is provided between browsing portion 53 and data communication control portion 117, so that conversion portion 51 receives a download instruction directed to data communication control portion 117 that is issued by browsing portion 53, and outputs the received download instruction to data communication control portion 117. Further, conversion portion 51 receives from data communication control portion 117 the Web page that data communication control portion 117 has received, converts the received Web page, and outputs the resultant Web page to browsing portion 53.

Conversion portion 51 includes: a data acquiring portion 61 to acquire a Web page (i.e., page data) based on a download instruction input from browsing portion 53; an analyzing portion 63 to analyze the Web page; an assigning portion 65 to assign operations to a plurality of keys; and an operation display adding portion 67 to display operation identification information for identifying the operations assigned to the keys.

Data acquiring portion 61 receives a download instruction directed to data communication control portion 117 that is issued by browsing portion 53, and outputs the received download instruction to data communication control portion 117. The download instruction includes a URL that a user has input to operation portion 115. Upon receipt of the download instruction, data communication control portion 117 downloads the Web page specified by the URL included in the download instruction from one of Web servers 7, 7A, and outputs the downloaded Web page to CPU 111. Data acquiring portion 61 receives the Web page output from data communication control portion 117, and outputs the Web page to analyzing portion 63. A Web page is page data which is written in a markup language such as hypertext markup language (HTML) or extensible markup language (XML).

Analyzing portion 63 analyzes the Web page input from data acquiring portion 61 to extract operations to be performed on the Web page. Specifically, analyzing portion 63 detects a vertical length and a horizontal length of the Web page, and compares these lengths with a vertical length and a horizontal length of a maximum displayable area (hereinafter, referred to as the “display area”) on display portion 114, to determine whether the vertical length and the horizontal length of the Web page are longer than the vertical length and the horizontal length, respectively, of the display area on display portion 114. If the vertical length of the Web page is longer than the vertical length of the display area on display portion 114, analyzing portion 63 determines that a vertical scroll operation and a vertical shift operation are necessary. If the horizontal length of the Web page is longer than the horizontal length of the display area on display portion 114, analyzing portion 63 determines that a horizontal scroll operation and a horizontal shift operation are necessary. The scroll operation and the shift operation are operations for designating a partial area in the Web page which has the same size as that of the display area on display portion 114. Analyzing portion 63 outputs to assigning portion 65 operation identification information for identifying the scroll and shift operations which analyzing portion 63 has determined to be necessary.

Analyzing portion 63 also detects commands provided in the Web page. The commands may include: a command to accept an operation of selecting or deselecting a radio button; a command to accept an operation of selecting or deselecting a check box; a command to accept an operation of instructing display of a drop-down list; and a command to accept text which is input into a text box. Analyzing portion 63 outputs the detected commands to assigning portion 65.

Further, analyzing portion 63 determines whether the Web page includes a field for inputting numerical characters. In the case where the Web page includes the field for inputting the numerical characters, analyzing portion 63 informs assigning portion 65 that the Web page includes such a field.

Assigning portion 65 assigns operations to a plurality of keys included in operation portion 115. In the case where a text box for accepting numerical characters is detected in the Web page by analyzing portion 63, assigning portion 65 assigns the operations to the keys in operation portion 115 other than the numeric keys in ten-key pad 201, because the numeric keys in ten-key pad 201 are used for inputting the numerical characters.

Assigning portion 65 controls operation control portion 55 to assign, to a respective key included in operation portion 115, a key code which functions as a trigger to cause browsing portion 53 to perform a process corresponding to an operation. The key codes to function as the triggers are predetermined in browsing portion 53 or in the page data. When a key to which an operation is assigned by assigning portion 65 is designated, operation control portion 55 outputs the key code assigned to that key to browsing portion 53. Accordingly, in response to the event that a key to which an operation is assigned is designated, browsing portion 53 performs a process corresponding to that operation.

Specifically, in the case where assigning portion 65 receives the operation identification information for identifying the scroll and shift operations from analyzing portion 63, assigning portion 65 determines keys among the plurality of keys included in operation portion 115 to which the scroll and shift operations are to be assigned. Assigning portion 65 then controls operation control portion 55 to assign, to a respective one of the determined keys, a key code which functions as a trigger to cause browsing portion 53 to perform a process that corresponds to the operation identified by the operation identification information when the relevant key is designated.

The process corresponding to the scroll operation or the shift operation is the process of moving up or down, or right or left, the partial area in the Web page which has the same size as the display area on display portion 114. Specifically, the process corresponding to the operation having the operation identification information “scroll up” is the process of moving the partial area upward by a distance identical to the vertical length of the partial area. The process corresponding to the operation having the operation identification information “scroll down” is the process of moving the partial area downward by a distance identical to the vertical length of the partial area. The process corresponding to the operation having the operation identification information “scroll right” is the process of moving the partial area rightward by a distance identical to the horizontal length of the partial area. The process corresponding to the operation having the operation identification information “scroll left” is the process of moving the partial area leftward by a distance identical to the horizontal length of the partial area.

The process corresponding to the operation having the operation identification information “upward shift” is the process of moving the partial area upward by a distance identical to the vertical size of a letter. The process corresponding to the operation having the operation identification information “downward shift” is the process of moving the partial area downward by a distance identical to the vertical size of a letter. The process corresponding to the operation having the operation identification information “rightward shift” is the process of moving the partial area rightward by a distance identical to the horizontal size of a letter. The process corresponding to the operation having the operation identification information “leftward shift” is the process of moving the partial area leftward by a distance identical to the horizontal size of a letter.

Further, assigning portion 65 determines two keys among the plurality of keys to which the operations are to be assigned. Assigning portion 65 then controls operation control portion 55 to assign, to a respective one of the determined keys, a key code which functions as a trigger to cause browsing portion 53 to perform a process of displaying the Web page with its display size enlarged or reduced, respectively, when the relevant key is designated. When the key to which the operation has been assigned by assigning portion 65 is designated, operation control portion 55 outputs to browsing portion 53 the key code which functions as a trigger to cause browsing portion 53 to perform the process corresponding to the operation assigned to that key. Assigning portion 65 outputs sets of key identification information, identifying a respective key to which an operation is assigned, and operation identification information, identifying the operation assigned to that key, to operation display adding portion 67.

It is noted that assigning portion 65 may add to a Web page a command to execute a process of displaying the Web page with its display size enlarged when one of the two determined keys is designated, and a command to execute a process of displaying the Web page with its display size reduced when the other one of the two determined keys is designated.

Furthermore, in the case where any command is received from analyzing portion 63, assigning portion 65 determines a key among the plurality of keys to which an operation of instructing execution of the command received from the analyzing portion 63 is to be assigned. Assigning portion 65 then controls operation control portion 55 to assign, to the determined key, a key code which functions as a trigger to cause browsing portion 53 to execute the command when the relevant key is designated. When the key to which the operation has been assigned by assigning portion 65 is designated, operation control portion 55 outputs to browsing portion 53 the key code assigned to that key. Assigning portion 65 outputs a set of key identification information, identifying the key to which the operation is assigned, and operation identification information, identifying the operation assigned to that key, to operation display adding portion 67.

It is noted that assigning portion 65 may generate an assignment command to execute the command received from analyzing portion 63 when the determined key is designated, and add the generated assignment command to the Web page. As a result, when the key to which the operation is assigned is designated, browsing portion 53 executes the assignment command added to the Web page, whereby the command is executed. In this case, assigning portion 65 outputs to operation display adding portion 67 a set of key identification information and operation identification information, wherein the key identification information is for identifying the key to which the operation to instruct execution of the command received from analyzing portion 63 is assigned, and the operation identification information is for identifying the operation assigned to that key, which corresponds to the identification information for the assignment command.

Operation display adding portion 67 stores the sets of key identification information and operation identification information in RAM 112, and causes display control portion 57 to display the sets of key identification information and operation identification information. As a result, when the Web page is displayed by browsing portion 53, the sets of key identification information and operation identification information are displayed. This tells the user what operation is assigned to what key among the plurality of keys 201 to 210 included in operation portion 115. In this case, display control portion 57 displays on display portion 114 an image of the Web page output from browsing portion 53, and an image of the sets of key identification information and operation identification information input from operation display adding portion 67.

It is noted that operation display adding portion 67 may add to a Web page a description for displaying the sets of key identification information and operation identification information when receiving the sets of key identification information and operation identification information from assigning portion 65. In this case, the sets of key identification information and operation identification information are output from browsing portion 53 to display control portion 57 and displayed by display control portion 57.

Operation control portion 55 controls operation portion 115. When a user makes an input to operation portion 115, if one of keys 201 to 210 is designated, operation control portion 55 accepts a key code assigned to the designated key, whereas if touch panel 115A is designated, operation control portion 55 accepts position information indicating the position designated on touch panel 115A. Operation control portion 55 outputs the accepted key code or positional information to browsing portion 53.

Browsing portion 53 displays on display portion 114 the Web page input from conversion portion 51. Furthermore, when receiving a key code from operation control portion 55, browsing portion 53 performs a process that is predetermined corresponding to the key code. In the case where the Web page input from conversion portion 51 includes an assignment command, when receiving a key code from operation control portion 55, browsing portion 53 executes the assignment command which is executed when the key identified with the input key code is designated.

Furthermore, in the case where the Web page input from conversion portion 51 includes a description for displaying the sets of key identification information and operation identification information, browsing portion 53 outputs an image of the sets of key identification information and operation identification information to display control portion 57. As a result, the sets of key identification information and operation identification information are displayed on display portion 114 by display control portion 57.

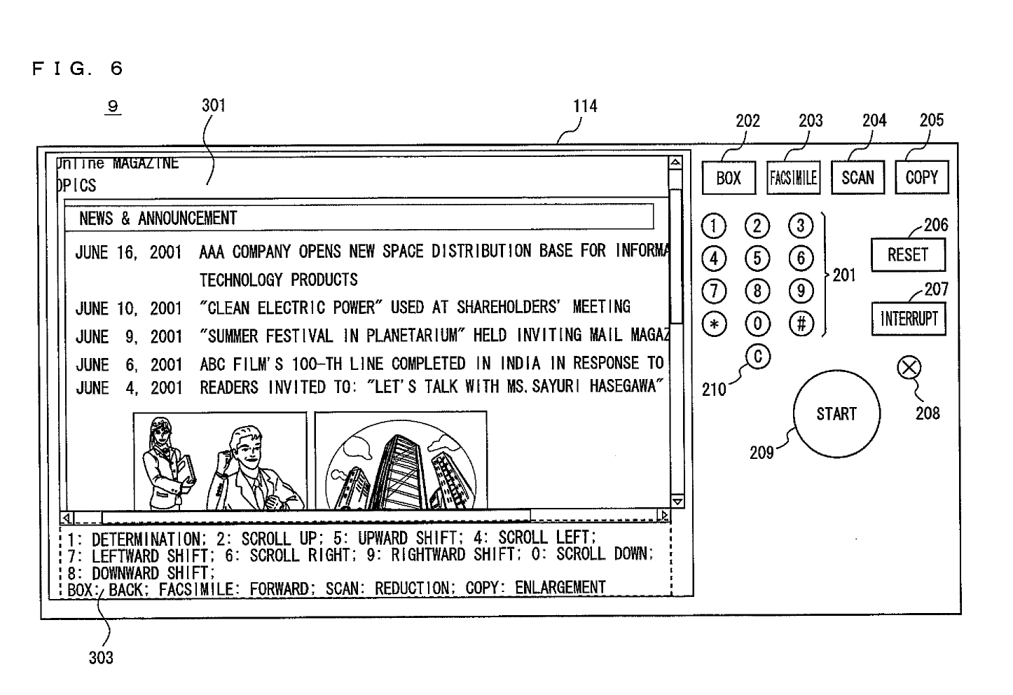

FIG. 6 is a first plan view showing an operation panel displaying a Web page. Referring to FIG. 6, display portion 114 on operation panel 9 displays a Web page 301, and an area 303 displaying sets of key identification information and operation identification information. Here, Web page 301 is larger in size than display portion 114. Area 303 displaying the sets of key identification information and operation identification information includes: a set of identification information “1” for the “1” key in ten-key pad 201 and operation identification information “determination”, a set of identification information “2” for the “2” key in ten-key pad 201 and operation identification information “scroll up”, a set of identification information “5” for the “5” key in ten-key pad 201 and operation identification information “upward shift”, a set of identification information “4” for the “4” key in ten-key pad 201 and operation identification information “scroll left”, a set of identification information “7” for the “7” key in ten-key pad 201 and operation identification information “leftward shift”, a set of identification information “6” for the “6” key in ten-key pad 201 and operation identification information “scroll right”, a set of identification information “9” for the “9” key in ten-key pad 201 and operation identification information “rightward shift”, a set of identification information “0” for the “0” key in ten-key pad 201 and operation identification information “scroll down”, a set of identification information “8” for the “8” key in ten-key pad 201 and operation identification information “downward shift”, a set of identification information “box” for box key 202 and operation identification information “back”, a set of identification information “facsimile” for facsimile key 203 and operation identification information “forward”, a set of identification information “scan” for scan key 204 and operation identification information “reduction”, and a set of identification information “copy” for copy key 205 and operation identification information “enlargement”.

Therefore, the determination operation is assigned to the “1” key in ten-key pad 201, the scroll-up operation which moves the Web page upward by one screen is assigned to the “2” key in ten-key pad 201, the upward shift operation which moves the Web page upward by one character is assigned to the “5” key in ten-key pad 201, the scroll-left operation which moves the Web page leftward by one screen is assigned to the “4” key in ten-key pad 201, the leftward shift operation which moves the Web page leftward by one character is assigned to the “7” key in ten-key pad 201, the scroll-right operation which moves the Web page rightward by one screen is assigned to the “6” key in ten-key pad 201, the rightward shift operation which moves the Web page rightward by one character is assigned to the “9” key in ten-key pad 201, the scroll-down operation which moves the Web page downward by one screen is assigned to the “0” key in ten-key pad 201, the downward shift operation which moves the Web page downward by one character is assigned to the “8” key in ten-key pad 201, the back operation by which the screen is returned to the previous Web page is assigned to box key 202, the forward operation by which the screen is forwarded to the next Web page is assigned to facsimile key 203, the reduction operation by which the Web page is reduced in display size is assigned to scan key 204, and the enlargement operation by which the Web page is enlarged in display size is assigned to copy key 205.

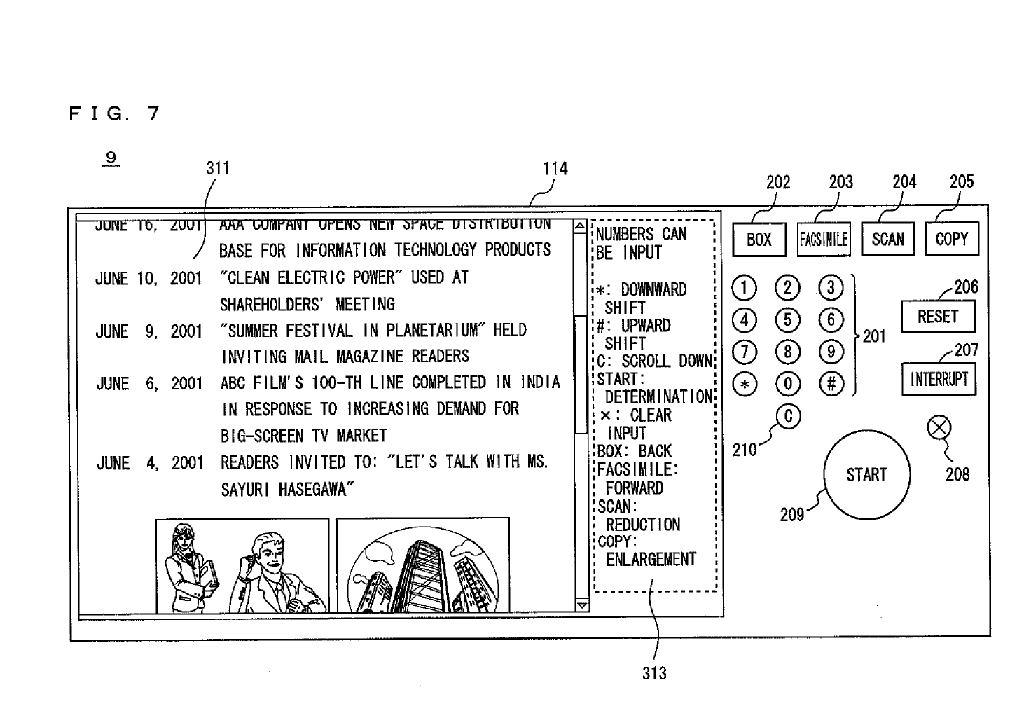

FIG. 7 is a second plan view showing an operation panel displaying a Web page. Referring to FIG. 7, display portion 114 on operation panel 9 displays a Web page 311, and an area 313 displaying sets of key identification information and operation identification information. Here, Web page 311 is horizontally shorter and vertically longer than display portion 114. Area 313 displaying the sets of key identification information and operation identification information includes: a set of identification information “*” for the “*” key in ten-key pad 201 and operation identification information “downward shift”, a set of identification information “#” for the “#” key in ten-key pad 201 and operation identification information “upward shift”, a set of identification information “C” for clear key 210 and operation identification information “scroll down”, a set of identification information “start” for start key 209 and operation identification information “determination”, a set of identification information “x” for pause key 208 and operation identification information “clear input”, a set of identification information “box” for box key 202 and operation identification information “back”, a set of identification information “facsimile” for facsimile key 203 and operation identification information “forward”, a set of identification information “scan” for scan key 204 and operation identification information “reduction”, and a set of identification information “copy” for copy key 205 and operation identification information “enlargement”.

Therefore, the downward shift operation is assigned to the “*” key in ten-key pad 201, the upward shift operation is assigned to the “#” key in ten-key pad 201, the scroll-down operation is assigned to clear key 210, the determination operation is assigned to start key 209, the clear input operation which clears strings input is assigned to pause key 208, the back operation is assigned to box key 202, the forward operation is assigned to facsimile key 203, the reduction operation is assigned to scan key 204, and the enlargement operation is assigned to copy key 205.

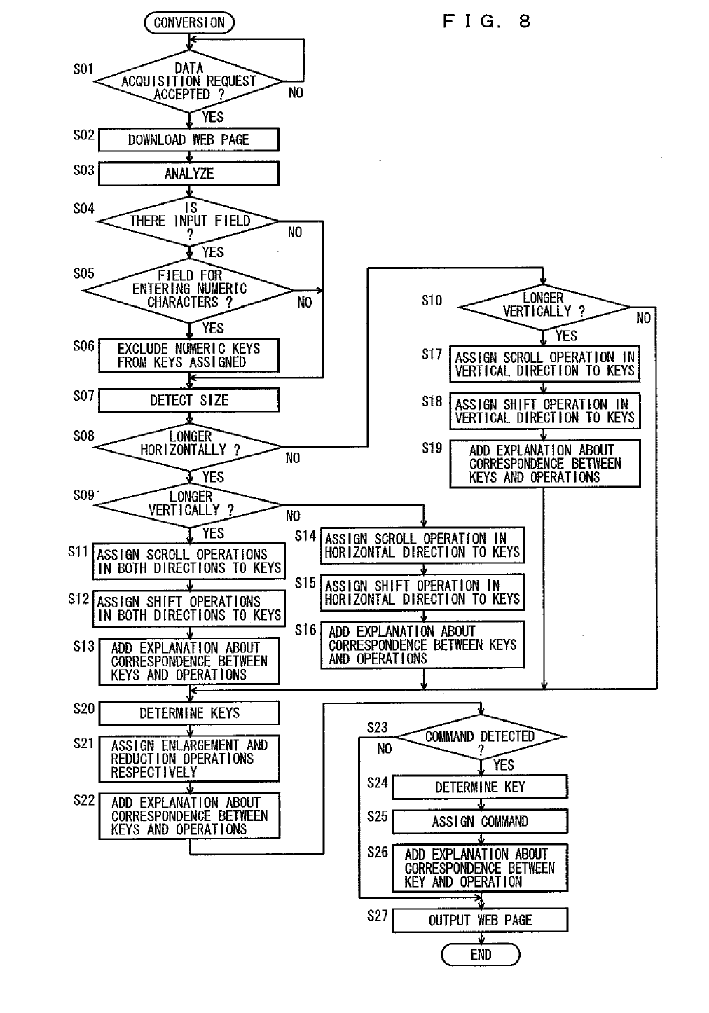

FIG. 8 is a flowchart illustrating an example of the flow of conversion processing. The conversion processing is carried out by CPU 111 as CPU 111 executes a data processing program. Referring to FIG. 8, CPU 111 determines whether a data acquisition request has been accepted (step S01). CPU 111 is in a standby mode until a data acquisition request is accepted (NO in step S01), and once the data acquisition request is accepted, the process proceeds to step S02. Specifically, when a download instruction is output from a browsing program which CPU 111 executes together with the data processing program, the download instruction is accepted as the data acquisition request. That is, the conversion processing is carried out provided that CPU 111 executing the browsing program outputs the data acquisition request.

In step S02, the Web page specified by the URL included in the data acquisition request is downloaded. CPU 111 acquires the data specified by the URL by requesting one of Web servers 7, 7A connected to Internet 3 that is specified by the URL to download the data.

Next, the Web page which has been downloaded is analyzed (step S03). It is then determined, based on a result of the analysis, whether the Web page includes an input field (step S04). If the Web page includes an input field, the process proceeds to step S05; otherwise, the process proceeds to step S07. In step S05, it is determined whether the input field is a field for inputting numerical characters. If the input field is the field for inputting the numerical characters, the process proceeds to step S06; otherwise, the process proceeds to step S07. In step 06, numeric keys in the ten-key pad are excluded from the keys to which the operations are to be assigned. In the case where the Web page includes the field for inputting the numerical characters, a user can input the numerical characters using the numeric keys in the ten-key pad, because no operations will be assigned to those keys.

In step S07, the size of the Web page is detected. In the following step S08, it is determined whether the Web page is horizontally longer than the display area on display portion 114. If so, the process proceeds to step S09; otherwise, the process proceeds to step S10. In step S09, it is determined whether the Web page is vertically longer than the display area on display portion 114. If so, the process proceeds to step S11; otherwise, the process proceeds to step S14.

On the other hand, in step S10, it is determined whether the Web page is vertically longer than the display area on display portion 114. If so, the process proceeds to step S17; otherwise, the process proceeds to step S20.

In step S11, the scroll operations in both vertical and horizontal directions are assigned to the corresponding keys. In the following step S12, the shift operations in both vertical and horizontal directions are assigned to the corresponding keys. An explanation about the correspondence between the operations and the keys to which the operations are assigned is added (step S13), and the process proceeds to step S20. Specifically, in the step of adding the explanation about the correspondence between the operations and the keys to which the operations are assigned, as in steps S13, S16, and S19, the sets of key identification information and operation identification information are displayed on display portion 114. It is noted that a description for displaying the sets of key identification information and operation identification information may be added to the Web page downloaded in step S02.

In step S14, the scroll operation in the horizontal direction is assigned to the corresponding keys. In the following step S15, the shift operation in the horizontal direction is assigned to the corresponding keys. Furthermore, an explanation about the correspondence between the operations and the keys to which the operations are assigned is added (step S16), and the process proceeds to step S20.

In step S17, the scroll operation in the vertical direction is assigned to the corresponding keys. In the following step S18, the shift operation in the vertical direction is assigned to the corresponding keys. Furthermore, an explanation about the correspondence between the operations and the keys to which the operations are assigned is added (step S19), and the process proceeds to step S20.

In step S20, two keys among the plurality of keys included in operation portion 115 to which no operations have been assigned yet are determined. Then, the enlargement operation and the reduction operation are assigned to one and the other of the determined keys. Specifically, a key code which functions as a trigger to cause browsing portion 53 to display the Web page with its display size enlarged is assigned to one of the determined keys, while a key code which functions as a trigger to cause browsing portion 53 to display the Web page with its display size reduced is assigned to the other of the determined keys (step S21). Then, a description for displaying the set of the key identification information for the one key determined in step S20 and the operation identification information for the display enlargement operation, and the set of the key identification information for the other key determined in step S20 and the operation identification information for the display reduction operation, is added to the Web page (step S22).

In step S23, it is determined whether a command has been detected in step S03. If so, the process proceeds to step S24; otherwise, the process proceeds to step S27. If a plurality of commands has been detected, steps S24 to S26 are performed for the respective commands.

In step S24, a key among the plurality of keys included in operation portion 115 to which no operation has been assigned yet is determined. Then, an operation of instructing execution of the command detected in step S23 is assigned to the determined key (step S25). Specifically, a key code which functions as a trigger to cause browsing portion 53 to execute the command detected in step S23 is assigned to the determined key. A description for displaying the set of the key identification information for the key determined in step S24 and the operation identification information for the operation instructing execution of the command detected in step S23 is added to the Web page (step S26).

In the following step S27, the Web page is output before the conversion processing is terminated. The Web page is output to the process which is generated by causing CPU 111 to execute the browsing program.

As described above, according to the present embodiment, MFP 100 has the browsing function. After downloading a Web page, MFP 100 analyzes the Web page to extract any operation to be performed on the Web page, and assigns at least one operation to at least one of a plurality of keys 201 to 210. It then displays at least one set of key identification information for the key among the plurality of keys 201 to 210 to which an operation is assigned and operation identification information for identifying the operation which is assigned to that key. As a result, the operations to be performed on the Web page are assigned to the keys among the plurality of keys 201 to 210. Thus, a user can perform the operations such as scroll, shift, enlargement, reduction, and the like on the Web page by designating the corresponding ones of the plurality of keys 201 to 210. When the Web page is displayed, the sets of key identification information for identifying the keys to which operations are assigned and operation identification information for identifying the operations assigned to the corresponding keys are displayed. This informs the user of the operations assigned to the respective ones of the plurality of keys 201 to 210.

Instead of displaying the sets of key identification information for identifying the keys among the plurality of keys 201 to 210 to which operations are assigned and operation identification information for identifying the operations assigned to those keys, a description for displaying the sets of key identification information for identifying the keys among the plurality of keys 201 to 210 to which the operations are assigned and operation identification information for identifying the operations assigned to those keys may be added to the Web page. In this manner as well, the sets of key identification information for identifying the keys among the plurality of keys 201 to 210 to which the operations are assigned and operation identification information for identifying the operations assigned to those keys may be displayed when the browsing program displays the converted Web page.

Further, MFP 100 determines a key among the plurality of keys 201 to 210 to which an operation is to be assigned, and controls to generate a key code which is predetermined for a process corresponding to the operation when the determined key is designated. This makes it possible to assign an operation to a key, without modifying the Web page.

In the case where the Web page includes a field for inputting numerical characters, the operations are assigned to the keys among the plurality of keys 201 to 210 except for the numeric keys in ten-key pad 201, thereby allowing the user to input the numerical characters using the numeric keys in ten-key pad 201.

While MFP 100 has been described as an example of the data processing apparatus in the above embodiment, the present invention may of course be understood as a data processing method for causing a computer controlling MFP 100 to perform the processing shown in FIG. 8, or a data processing program for causing the computer to execute the data processing method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data processing apparatus comprising:
an operation accepting portion to accept an operation of a user, the operation accepting portion having a plurality of keys;
a display control portion to display data;
a data acquiring portion to acquire page data written in a markup language;
a browsing portion to cause said display control portion to display the page data;
an analyzing portion to analyze said acquired page data to extract an operation to be performed on said acquired page data;
an assigning portion to assign at least one operation to at least one of said plurality of keys based on a result of said analysis; and
an operation display portion to cause said display control portion to display at least one set of key identification information for identifying the key among said plurality of keys to which an operation is assigned and operation identification information for identifying the operation which is assigned to the key.

2. The data processing apparatus according to claim 1, further comprising an operation control portion to control said operation accepting portion, wherein
said assigning portion determines a key among said plurality of keys to which said operation is to be assigned, and controls said operation control portion to generate a key code which is predetermined for a process corresponding to said operation when said determined key is designated.

3. The data processing apparatus according to claim 2, wherein
said analyzing portion detects a display size of said acquired page data, and
when the display size of said page data is larger than a maximum displayable size, said assigning portion determines two keys among said plurality of keys to which operations are to be assigned, and controls said operation control portion to generate key codes which are predetermined corresponding to processes of moving a partial area in said page data having a same size as the maximum displayable size up and down, or right and left, respectively, when said determined keys are designated.

4. The data processing apparatus according to claim 2, wherein said assigning portion determines two keys among said plurality of keys to which operations are to be assigned, and controls said operation control portion to generate a key code which is predetermined corresponding to a process of displaying said page data with its display size enlarged when one of said determined keys is designated and to generate another key code which is predetermined corresponding to a process of displaying said page data with its display size reduced when the other of said determined keys is designated.

5. The data processing apparatus according to claim 2, wherein in the case where said analyzing portion detects a command in said acquired page data, said assigning portion determines a key among said plurality of keys to which an operation of instructing execution of said detected command is to be assigned, and controls said operation control portion to generate a key code which is predetermined corresponding to a process of executing said detected command when said determined key is designated.

6. The data processing apparatus according to claim 1, wherein in the case where said analyzing portion detects an area for accepting numerical characters in said acquired page data, said assigning portion assigns said operation to a key other than numeric keys among said plurality of keys.

7. The data processing apparatus according to claim 1, wherein said assigning portion determines a key among said plurality of keys to which said operation is to be assigned, and adds to said acquired page data an assignment command to execute a process corresponding to said operation when said determined key is designated.

8. A data processing apparatus comprising:
an operation accepting portion to accept an operation of a user, the operation accepting portion having a plurality of keys;
a data acquiring portion to acquire page data written in a markup language;
an analyzing portion to analyze said acquired page data to extract an operation to be performed on said acquired page data;
an assigning portion to assign at least one operation to at least one of said plurality of keys based on a result of said analysis; and
an adding portion to add to said page data a description for displaying at least one set of key identification information for identifying the key among said plurality of keys to which an operation is assigned and operation identification information for identifying the operation which is assigned to the key.

9. The data processing apparatus according to claim 8, further comprising an operation control portion to control said operation accepting portion, wherein
said assigning portion determines a key among said plurality of keys to which said operation is to be assigned, and controls said operation control portion to generate a key code which is predetermined for a process corresponding to said operation when said determined key is designated.

10. The data processing apparatus according to claim 9, wherein
said analyzing portion detects a display size of said acquired page data, and
when the display size of said page data is larger than a maximum displayable size, said assigning portion determines two keys among said plurality of keys to which operations are to be assigned, and controls said operation control portion to generate key codes which are predetermined corresponding to processes of moving a partial area in said page data having a same size as the maximum displayable size up and down, or right and left, respectively, when said determined keys are designated.

11. The data processing apparatus according to claim 9, wherein said assigning portion determines two keys among said plurality of keys to which operations are to be assigned, and controls said operation control portion to generate a key code which is predetermined corresponding to a process of displaying said page data with its display size enlarged when one of said determined keys is designated and to generate another key code which is predetermined corresponding to a process of displaying said page data with its display size reduced when the other of said determined keys is designated.

12. The data processing apparatus according to claim 9, wherein in the case where said analyzing portion detects a command in said acquired page data, said assigning portion determines a key among said plurality of keys to which an operation of instructing execution of said detected command is to be assigned, and controls said operation control portion to generate a key code which is predetermined corresponding to a process of executing said detected command when said determined key is designated.

13. The data processing apparatus according to claim 8, wherein in the case where said analyzing portion detects an area for accepting numerical characters in said acquired page data, said assigning portion assigns said operation to a key other than numeric keys among said plurality of keys.

14. The data processing apparatus according to claim 8, wherein said assigning portion determines a key among said plurality of keys to which said operation is to be assigned, and adds to said acquired page data an assignment command to execute a process corresponding to said operation when said determined key is designated.

15. A data processing method carried out in a computer, the computer including an operation accepting portion and a display control portion, the operation accepting portion having a plurality of keys and accepting an operation of a user, the display control portion displaying data, the method comprising the steps of:
acquiring page data which is written in a markup language;
causing said display control portion to display the page data;
analyzing said acquired page data;
assigning at least one operation to at least one of said plurality of keys based on a result of said analysis; and
causing said display control portion to display at least one set of key identification information for identifying the key among said plurality of keys to which an operation is assigned and operation identification information for identifying the operation which is assigned to the key.

16. The data processing method according to claim 15, wherein
said computer further includes an operation control portion to control said operation accepting portion, and wherein
said assigning step includes the steps of:
determining a key among said plurality of keys to which said operation is to be assigned; and
controlling said operation control portion to generate a key code which is predetermined for a process corresponding to said operation when said determined key is designated.

17. A data processing method carried out in a computer, the computer including an operation accepting portion having a plurality of keys and accepting an operation of a user, the method comprising the steps of:
acquiring page data which is written in a markup language;
analyzing said acquired page data;
assigning at least one operation to at least one of said plurality of keys based on a result of said analysis; and
adding to said page data a description for displaying at least one set of key identification information for identifying the key among said plurality of keys to which an operation is assigned and operation identification information for identifying the operation which is assigned to the key.

18. The data processing method according to claim 17, wherein
said computer further includes an operation control portion to control said operation accepting portion, and wherein
said assigning step includes the steps of:
determining a key among said plurality of keys to which said operation is to be assigned; and
controlling said operation control portion to generate a key code which is predetermined for a process corresponding to said operation when said determined key is designated.

19. A data processing program embodied on a computer readable medium, the program being executed by a computer including an operation accepting portion and a display control portion, the operation accepting portion having a plurality of keys and accepting an operation of a user, the display control portion displaying data, the program causing said computer to execute the steps of:
acquiring page data which is written in a markup language;
causing said display control portion to display the page data;
analyzing said acquired page data;
assigning at least one operation to at least one of said plurality of keys based on a result of said analysis; and
causing said display control portion to display at least one set of key identification information for identifying the key among said plurality of keys to which an operation is assigned and operation identification information for identifying the operation which is assigned to the key.

20. A data processing program embodied on a computer readable medium, the program being executed by a computer including an operation accepting portion, the operation accepting portion having a plurality of keys and accepting an operation of a user, the program causing said computer to execute the steps of:
acquiring page data which is written in a markup language;
analyzing said acquired page data;
assigning at least one operation to at least one of said plurality of keys based on a result of said analysis; and
adding to said page data a description for displaying at least one set of key identification information for identifying the key among said plurality of keys to which an operation is assigned and operation identification information for identifying the operation which is assigned to the key.
